(19) United States
(12) Patent Application Publication
(10) Pub. No.: US 2016/0207156 A1
(43) Pub. Date: Jul. 21, 2016

(54) ROTARY TABLE AND CLAMPING MECHANISM

(71) Applicant: FANUC Corporation, Yamanashi (JP)

(72) Inventor: Zhizhen XIA, Yamanashi (JP)

(21) Appl. No.: 14/996,672

(22) Filed: Jan. 15, 2016

(30) Foreign Application Priority Data
Jan. 16, 2015 (JP) 2015-007179

(51) Int. Cl. B23Q 16/10; F16D 55/24; F16D 55/02

(52) U.S. Cl. CPC B23Q 16/105; F16D 55/025; F16D 55/24; F16D 55/02

(57) ABSTRACT

A rotary table, which is provided with a rotating shaft rotatably disposed in a casing and a clamping mechanism configured to disable the rotating shaft from rotating, is designed so that another clamping mechanism, in addition to the first clamping mechanism, can be connected to the rotating shaft, whereby a clamping torque twice that of a rotary table with a single clamping mechanism can be produced.

### BACKGROUND OF THE INVENTION

1. Field of the Invention

The present invention relates to a rotary table and a clamping mechanism used in a machine tool.

2. Description of the Related Art

In recent years, rotary tables have become widely used in machine tools. In particular, the rotary tables are frequently used to perform indexing operations, and the reliability of the indexing operations and clamping mechanisms is an important element of the rotary tables.

In general, an irreversible worm gear mechanism is used as a rotating mechanism of a rotary table (see, for example, Japanese Patent Application Laid-Open No. 2002-18678). Since the worm gear mechanism of this type is constructed so that a worm and a worm wheel mesh with each other, it is subject to backlash, though very small. Even when the table is stationary, therefore, looseness corresponding to the amount of the backlash is caused, so that an indexed angle of the table may be deviated to adversely affect the machining accuracy of a workpiece held on the table.

In order to solve the above problem, there are provided a brake disk, which is rotated together with a spindle for transmitting rotary motion from a rotary drive unit to the table, and a piston capable of holding the brake disk in conjunction with a cylinder. An air pressure is applied to the piston to hold the brake disk between the piston and the cylinder. The motion of the spindle that connects with the brake disk is restricted by a frictional force generated between the brake disk and a fixing member, whereby the rotary table connecting with the spindle is kept standstill state (see, for example, Japanese Patent Application Laid-Open No. 2012-202484).

A clamping mechanism of the rotary table requires a high clamping torque to cope with heavy cutting and heavy loads. In the conventional rotary table, the clamping torque is produced by using a single brake disk, so that its magnitude is insufficient. Further, there is no existing means for easily increasing the clamping torque in the case where a high clamping torque is required after the rotary table is installed by a user.

### SUMMARY OF THE INVENTION

Accordingly, in view of the prior art problems described above, the object of the present invention is to provide a rotary table capable of providing a high clamping torque and a clamping mechanism of the rotary table.

A rotary table according to the present invention comprises a rotating shaft rotatably disposed in a casing and a clamping mechanism configured to disable the rotating shaft from rotating. The clamping mechanism comprises a first clamping mechanism and one or more second clamping mechanisms. The first clamping mechanism comprises a first cylinder secured or removably disposed in the casing, a first piston provided in a first space section defined in the first cylinder and configured to reciprocate in the first space section as a working fluid is delivered to or from the first space section, and a first brake disk configured to engage the first piston, thereby disabling the rotating shaft from rotating. On the other hand, the at least one second clamping mechanism comprises a second cylinder removably disposed relative to the first cylinder, a second piston provided in a second space section defined in the second cylinder and configured to reciprocate in the second space section as the working fluid is delivered to or from the second space section, and a second brake disk configured to engage the second piston, thereby disabling the rotating shaft from rotating.

A plurality of second clamping mechanisms may be mounted along the axis of the rotating shaft.

The first and second clamping mechanisms can be configured to be fitted with a lid each.

Further, a clamping mechanism according to the present invention is configured to be mounted in a multistage arrangement on a rotary table in order to disable a rotating shaft rotatably disposed in a casing from rotating and comprises a cylinder, a piston provided in a space section defined in the cylinder and configured to reciprocate in the space section as a working fluid is delivered to or from the space section, and a brake disk configured to engage the piston, thereby disabling the rotating shaft from rotating.

According to the present invention, there can be provided a rotary table capable of providing a high clamping torque and a clamping mechanism of the rotary table.

### BRIEF DESCRIPTION OF THE DRAWINGS

The above and other objects and features of the present invention will be obvious from the ensuing description of embodiments with reference to the accompanying drawings, in which:

FIG. 1 is a sectional view showing a basic structure of a rotary table;

FIG. 2 is a sectional view of one embodiment of a rotary table according to the present invention; and

FIG. 3 is an exterior view of one embodiment of the rotary table according to the present invention.

### DETAILED DESCRIPTION OF THE PREFERRED EMBODIMENTS

One embodiment of the present invention will now be described with reference to the accompanying drawings. In the rotary table according to the present embodiment, a motor for driving a rotating shaft is installed in a casing. However, the rotary table according to the present invention is not limited to the configuration in which the motor is disposed in the casing. For example, it may alternatively be a rotary table in which a motor is disposed outside a casing, as described in Japanese Patent Application Laid-Open No. 2002-18678 mentioned before, or a rotary table which includes no motor as a constituent element and in which a jig plate is supported for rotation, as described in Japanese Patent Application Laid-Open No. 2013-144321 mentioned before.

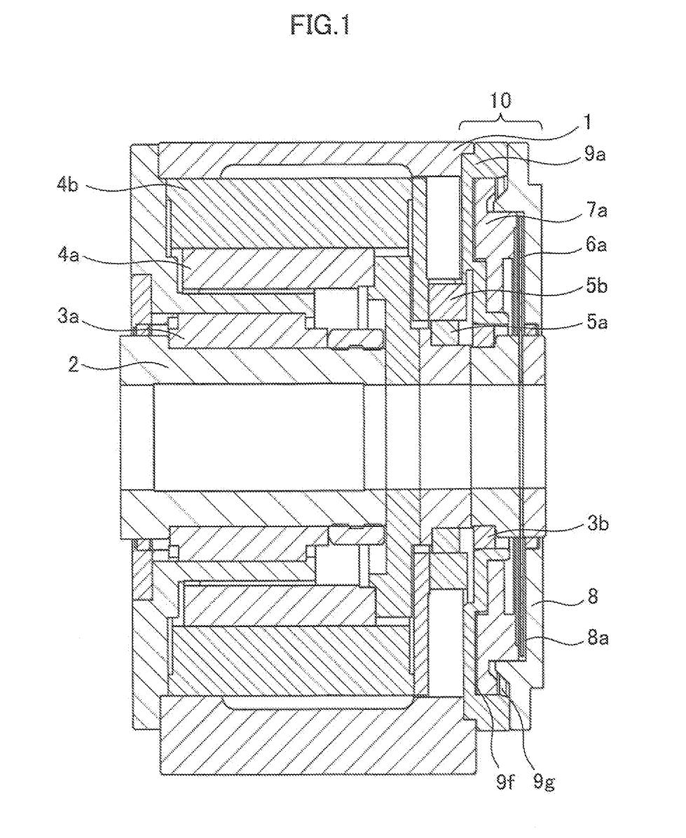

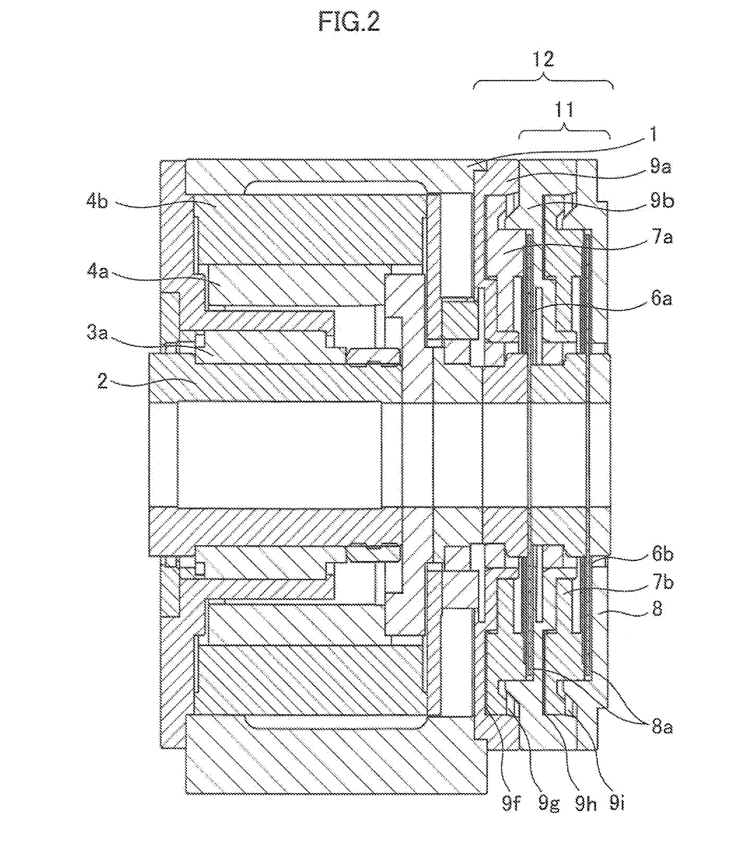

FIG. 1 is a sectional view showing a basic structure of the rotary table. FIG. 2 is a sectional view of one embodiment of the rotary table according to the present invention.

As shown in FIG. 1, a shaft 2 of the rotary table is rotatably supported by a main bearing 3a and a support bearing 3b in a casing 1. A stator 4b, cylinder 9a, sensor head 5b, and lid 8 are secured to the casing 1. On the other hand, a rotor 4a of the motor, sensor gear 5a, and disk 6a are all secured to the shaft 2 for integral rotation with the rotary table.

A piston 7a is provided having an advance/retreat stroke in the cylinder 9a. An advancing air chamber 9f and a retreating air chamber 9g are provided between the piston 7a and the cylinder 9a such that the piston 7a can be moved to the clamp side by compressed air.

In an unclamped state (clamp-release state), compressed air is delivered to the retreating air chamber 9g by a solenoid valve (or switching valve, not shown in FIG. 1) so that the piston 7a is moved to a retreat end (rear end).

In a clamped state, in contrast, the moment the retreating air chamber 9g is evacuated, compressed air is delivered to the advancing air chamber 9f. Thereupon, the piston 7a is advanced so that the disk 6a is held between a friction surface 8a on the lid 8.

The rotary table shown in FIG. 2 has a structure in which another clamping mechanism 11 is added to the rotary table of the basic structure as shown in FIG. 1. Such an additional clamping mechanism 11 can be attached to the clamping mechanism 11 in a manner such that they are superposed in an axial direction of the rotating shaft. Moreover, still another clamping mechanism of the same structure as the additional clamping mechanism 11 can further be attached to the additional clamping mechanism 11 (FIG. 2) in a manner such that they are superposed in an axial direction of the rotating shaft.

In the rotary table of the basic structure shown in FIG. 1, the lid 8 is removed, the additional clamping mechanism 11 is mounted in place, and the removed lid 8 is then attached to the clamping mechanism 11. A connecting cylinder 9b is secured to the cylinder 9a by bolts (not shown in FIG. 2). Further, an additional disk 6b is secured to the shaft 2 for integral rotation with the rotary table.

The advancing air chamber 9f and the retreating air chamber 9g are provided between the cylinder 9a and the piston 7a in the clamping mechanism so that the piston 7a, which has been mounted from the start, can be moved by compressed air.

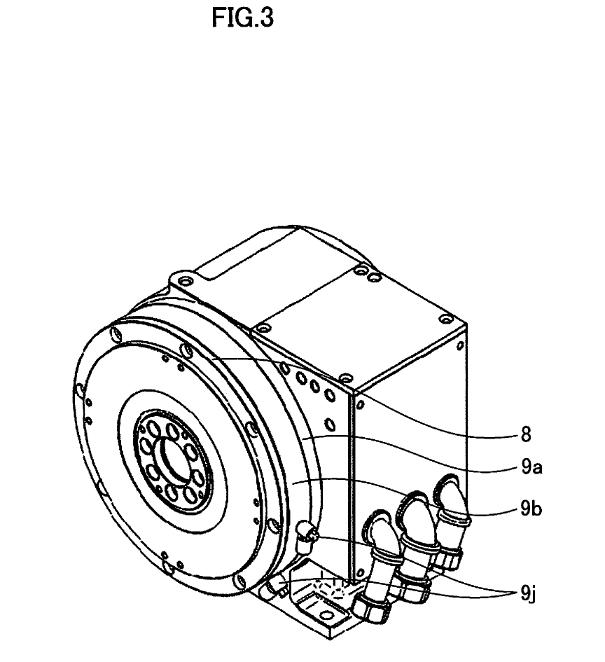

An advancing air chamber 9h and a retreating air chamber 9i are provided between the connecting cylinder 9b and the additional piston 7b in the additional clamping mechanism so that the additional piston 7b can be moved by compressed air. As shown in FIG. 3, small communication holes and joints 9j are provided on the outer peripheral portion of the connecting cylinder 9b in order to supply compressed air to the additional advancing air chamber 9h and the additional retreating chamber 9i.

In the clamped state, the piston 7a and the additional piston 7b are pressed against clamping surfaces that are opposed individually to the disk 6a and the additional disk 6b in the clamping mechanisms, and a clamping force is obtained using frictional forces on the respective contact surfaces. Since the rotary table shown in FIG. 2 comprises two clamping mechanisms, it can produce a clamping torque twice that of a rotary table with a single clamping mechanism. If a higher clamping force is required, clamping mechanisms of a number corresponding to a required increase in magnitude of the clamping torque should only be added, to the existing ones with the lid 8 removed.

According to the present invention, a plurality of clamping mechanisms are added to an original rotary table. In this arrangement, the clamping torque is obtained using the frictional forces on the contact surfaces by pressing the disks against the clamping surfaces opposed to the disks in the individual clamping mechanisms. Therefore, a high clamping torque can be produced taking advantage of the addition of the braking effect of the frictional forces. If the clamping torque is expected to be increased after the rotary table is installed, moreover, it can be achieved by simply providing additional clamping mechanisms in the field. Further, there can be provided a structure that can easily provide a high clamping torque at a site such as a factory where the machine tool is used after the rotary table is installed in the machine tool.

1. A rotary table which comprises a rotating shaft rotatably disposed in a casing and a clamping mechanism configured to disable the rotating shaft from rotating,
the clamping mechanism comprising:
a first clamping mechanism comprising a first cylinder secured or removably disposed in the casing, a first piston provided in a first space section defined in the first cylinder and configured to reciprocate in the first space section as a working fluid is delivered to or from the first space section, and a first brake disk configured to engage the first piston, thereby disabling the rotating shaft from rotating; and
at least one second clamping mechanism comprising a second cylinder removably disposed relative to the first cylinder, a second piston provided in a second space section defined in the second cylinder and configured to reciprocate in the second space section as the working fluid is delivered to or from the second space section, and a second brake disk configured to engage the second piston, thereby disabling the rotating shaft from rotating.

2. The rotary table according to claim 1, wherein a plurality of second clamping mechanisms are mounted along the axis of the rotating shaft.

3. The rotary table according to claim 1, wherein the first and second clamping mechanisms are configured to be fitted with a lid each.

4. A clamping mechanism configured to be mounted in a multistage arrangement on a rotary table in order to disable a rotating shaft rotatably disposed in a casing from rotating, the clamping mechanism comprising:
a cylinder;
a piston provided in a space section defined in the cylinder and configured to reciprocate in the space section as a working fluid is delivered to or from the space section; and
a brake disk configured to engage the piston, thereby disabling the rotating shaft from rotating.
